(19) United States
(12) Patent Application Publication
(10) Pub. No.: US 2017/0356832 A1
(43) Pub. Date: Dec. 14, 2017

(54) DEVICES AND METHOD FOR EVALUATING THE INTEGRITY OF SOIL BEHIND AN INFRASTRUCTURE

(71) Applicant: INVERSA SYSTEMS LTD., Fredericton (CA)

(72) Inventor: François ST-ONGE, Fredericton (CA)

(21) Appl. No.: 15/614,711

(22) Filed: Jun. 6, 2017

(30) Foreign Application Priority Data
Jun. 8, 2016 (CA) 2932663

(51) Int. Cl. G01N 3/34; G01M 7/02; G01N 27/76; G01N 27/82; G01N 27/90

(52) U.S. Cl. CPC G01N 3/34; G01M 7/025; G01N 27/76; G01M 7/022; G01N 27/9033; G01N 27/825

(57) ABSTRACT

There is disclosed a device for use in evaluating the integrity of soil behind a wall of an infrastructure. The device generally has a frame having a plurality of rests adapted to be received onto the wall during use; a hammer assembly having an actuator fixedly mounted to the frame and a hammer element having a head movably mounted to the frame, the actuator being actuatable to move the head to strike the wall while the plurality of rests hold the frame in a fixed position relative to the wall; and a sensor configured and adapted to sense vibrations of a portion of the wall resulting from the strike and to generate a vibration signal indicative thereof.

### FIELD

The improvements generally relate to methods and systems for inspecting a buried infrastructure such as a pipe and more particularly to methods and systems for evaluating the presence or absence of soil behind a wall of the buried infrastructure.

### BACKGROUND

Inspecting infrastructure such as culverts, levees and storm sewers is of relevance in order to manage maintenance thereof. For instance, such infrastructures can be provided in the form of underground channels allowing passage of water under roadways and are generally obtained by burying a large diameter pipe under soil (e.g., sand gravel and/or aggregates).

Culverts, levees and/or storm sewers can deteriorate over time due to, for instance, erosion of the soil surrounding the pipes. As the soil surrounding a pipe gradually erodes, voids can be created between the surrounding soil and the pipe, thus increasing risks of failure (e.g., washout due to flooding). As deterioration of such infrastructure depends on external physical factors, inspecting each infrastructure is key in providing a satisfactory maintenance plan.

Inspection of such infrastructures is typically provided in the form of visual inspection and/or acoustic inspection. There thus remains room for improvement.

### SUMMARY

In accordance with an aspect, there is provided a device for use in evaluating the integrity of soil behind a wall of an infrastructure, the device comprising: a frame having a plurality of rests adapted to be received onto the wall during use; a hammer assembly having an actuator fixedly mounted to the frame and a hammer element having a head movably mounted to the frame, the actuator being actuatable to move the head to strike the wall while the plurality of rests hold the frame in a fixed position relative to the wall; and a sensor configured and adapted to sense vibrations of a portion of the wall resulting from the strike and to generate a vibration signal indicative thereof.

In accordance with another aspect, there is provided a computer-implemented method of evaluating an integrity level of soil behind a wall of an infrastructure, the method comprising: activating an actuator to cause a hammer strike onto the wall; receiving a vibration signal representing vibrations of a portion of the wall after the hammer strike; determining at least one of a signal strength and a decay rate of the vibration signal; and assigning the at least one of the signal strength and the decay rate as the soil integrity level.

In accordance with another aspect, there is provided a computer-implemented method of evaluating an integrity level of soil behind a wall of an infrastructure, the method comprising: activating an actuator to cause a hammer strike onto the wall; receiving a vibration signal representing vibrations of a portion of the wall after the hammer strike; determining a decay rate of the vibration signal; and assigning the decay rate as the soil integrity level.

In accordance with another aspect, there is provided a computer-implemented method of evaluating an integrity level of soil behind a wall of an infrastructure, the method comprising: activating an actuator to cause a hammer strike onto the wall; receiving a vibration signal representing vibrations of a portion of the wall after the hammer strike; determining a signal strength of the vibration signal; and assigning the signal strength as the soil integrity level.

In accordance with another aspect, there is provided a device for evaluating an integrity level of soil behind a wall of an infrastructure, the device comprising: a computer-readable memory having stored thereon program code executable by a processor; and a processor configured for executing the program code, the processor being configured for: activating an actuator to cause a hammer strike onto the wall; receiving a vibration signal representing vibrations of a portion of the wall after the hammer strike; determining at least one of a signal strength and a decay rate of the vibration signal; and assigning the at least one of the signal strength and the decay rate as the soil integrity level.

In accordance with another aspect, there is provided a device for evaluating an integrity level of soil behind a wall of an infrastructure, the device comprising: a computer-readable memory having stored thereon program code executable by a processor; and a processor configured for executing the program code, the processor being configured for: activating an actuator to cause a hammer strike onto the wall; receiving a vibration signal representing vibrations of a portion of the wall after the hammer strike; determining a signal strength of the vibration signal; and assigning the signal strength as the soil integrity level.

In accordance with another aspect, there is provided a device for evaluating an integrity level of soil behind a wall of an infrastructure, the device comprising: a computer-readable memory having stored thereon program code executable by a processor; and a processor configured for executing the program code, the processor being configured for: activating an actuator to cause a hammer strike onto the wall; receiving a vibration signal representing vibrations of a portion of the wall after the hammer strike; determining a decay rate of the vibration signal; and assigning the decay rate as the soil integrity level.

Many further features and combinations thereof concerning the present improvements will appear to those skilled in the art following a reading of the instant disclosure.

### DESCRIPTION OF THE FIGURES

In the figures,

FIG. 1 is a schematic view of an exemplary device for evaluating the integrity of soil behind a wall of an infrastructure;

FIG. 2 is an axial view of a buried infrastructure having a cylindrical wall receiving, at a first portion thereof, the device of FIG. 1;

FIG. 2A is a graph of an exemplary vibration signal representing vibrations of the first portion after a hammer strike by the device of FIG. 1;

FIG. 3 is an axial view of a buried infrastructure having a cylindrical wall receiving, at a second portion thereof, the device of FIG. 1;

FIG. 3A is a graph of an exemplary vibration signal representing vibrations of the second portion after a hammer strike by the device of FIG. 1;

FIG. 4 is a flow chart of an example method for evaluating the integrity of soil behind a wall of an infrastructure using the device of FIG. 1;

FIG. 5 is a block diagram of an example of the device of FIG. 1;

FIGS. 6A-C are sectional views of an exemplary hammer assembly during a hammer strike on a wall of an infrastructure;

FIG. 7 is an image showing an embodiment of the device of FIG. 1;

FIG. 8 is an image showing another embodiment of a device for evaluating the integrity of soil behind a wall of an infrastructure;

FIG. 9 is a top view of an example of a sensor of the device of FIG. 8; and

FIG. 10 is a block diagram of another embodiment of a device for evaluating the integrity of soil behind a wall of an infrastructure portion.

### DETAILED DESCRIPTION

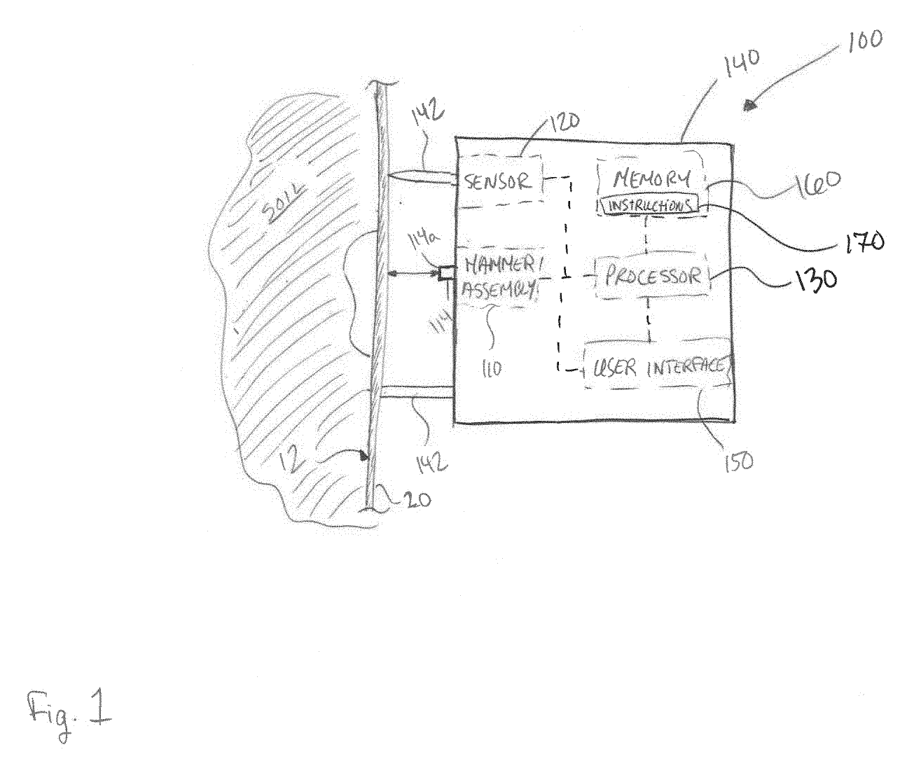

FIG. 1 shows an example of a device 100 that can be used for evaluating the integrity of soil behind a wall 20 of an infrastructure 12. Such an infrastructure can be a pipe typically having a cylindrical wall with an accessible inner face. The device 100 can be used also with pipes being corrugated along their lengths, i.e. corrugated pipes. In some embodiments, the device 100 can be used with other types of buried infrastructure.

Broadly described, the device 100 includes a hammer assembly 110 and a sensor 120 mounted directly or indirectly to a frame 140. The frame 140 can be provided in the form of a housing that may be water-resistant. As it will be described, the device 100 can have a processor 130 in communication with the sensor 120, with a computer-readable memory 160 and/or with the hammer assembly 110.

As shown in FIG. 1, the frame 140 has rests 142 adapted to be received onto the wall 20 of the infrastructure 12 during use. The hammer assembly 110 has an actuator fixedly mounted to the frame 140 and a hammer element 114. The hammer element 114 has a head 114a movably mounted to the frame 140. The actuator is actuatable to move the head 114a to strike against the wall 20 while the rests 142 hold the frame 140 in a fixed position relative to the wall 20. The strike can cause a portion of the wall 20 to vibrate for a given period of time. Any suitable type of actuator can be used to perform such a function. For instance, the actuator can be hydraulic, pneumatic, electric, thermal, magnetic, mechanical and/or any combination thereof.

The sensor 120 is configured and adapted to generate a vibration signal representing vibrations of the portion of the wall 20 after the strike from the head 114a of the hammer element 114.

For instance, in the embodiment shown, the sensor 120 can be made integral to a sensing one of the rests 142, and the sensing one of the rests 142 has a pointed tip. As depicted, the hammer assembly 110 can be surrounded by the rests 142 such that the hammer element 114 strikes a point proximate that of the sensor 120. In some embodiments, the rests are provided in a narrow linear arrangement such as to be positioned along a corrugation of a corrugated pipe. In some other embodiments, the rests 142 are provided with pressure-sensitive sensors allowing to maintain the rests 142 received onto the wall 20 at a given pressure. This can allow uniformity and repeatability between successive measurements.

The mechanical strike can be initiated by a user input received at a user interface 150 of the device 100. In an embodiment, the user interface 150 is embodied by a trigger switch mounted to the frame 140. The user interface 150 can be provided in any other suitable forms. For instance, in alternate embodiments, the user interface is embodied by a touch-sensitive liquid crystal display or a remote external device (e.g., a smart phone or an electronic tablet).

After the mechanical strike, the sensor 120 can pick up the vibrations of the portion of the wall 20 and generate a vibration signal representing the vibrations of the wall 20. The vibration signal can be analyzed by the processor 130 to evaluate the integrity of soil behind the wall 20 such as evaluating if there is a presence or an absence of soil behind the wall 20. The evaluation of the integrity of soil behind the wall 20 can be performed by instructions 170 stored on the memory 160 and executable by the processor 130 to measure a value indicative of soil integrity behind the wall based on the vibration signal. The value (or soil integrity level) can include a decay rate, a signal strength, a mean amplitude, a frequency and/or a combination thereof. In some embodiments, the processor 130 and the memory 160 are part of a computer.

Once generated, the soil integrity level can be displayed on the user interface 150.

It is appreciated that the hammer assembly 110 is designed such that it can mechanically strike the wall 20 with a substantially repeatable force. Knowing the force at which the wall 20 is stroke by the hammer assembly 110 with a satisfactory accuracy can reduce several variables that can cause artifacts in the vibration signal. Such variables can include an initial amplitude of the vibrations in the portion of the wall 20, an angle of impact and multiple strikes.

It is noted that the processor 130 is in a wired communication and/or in a wireless communication with the hammer assembly 110, the sensor 120 and the user interface 150. It is further noted that the processor 130 can be provided in the form of a microcomputer having a non-volatile memory and firmware and/or a processor in communication with a computer-readably memory. The instructions 170 can include signal processing algorithms, reference and/or threshold values for use in generating the value, which can be stored on a memory of the processor 130 once determined. The processor 130 can include a power source such as a battery (e.g., a rechargeable battery).

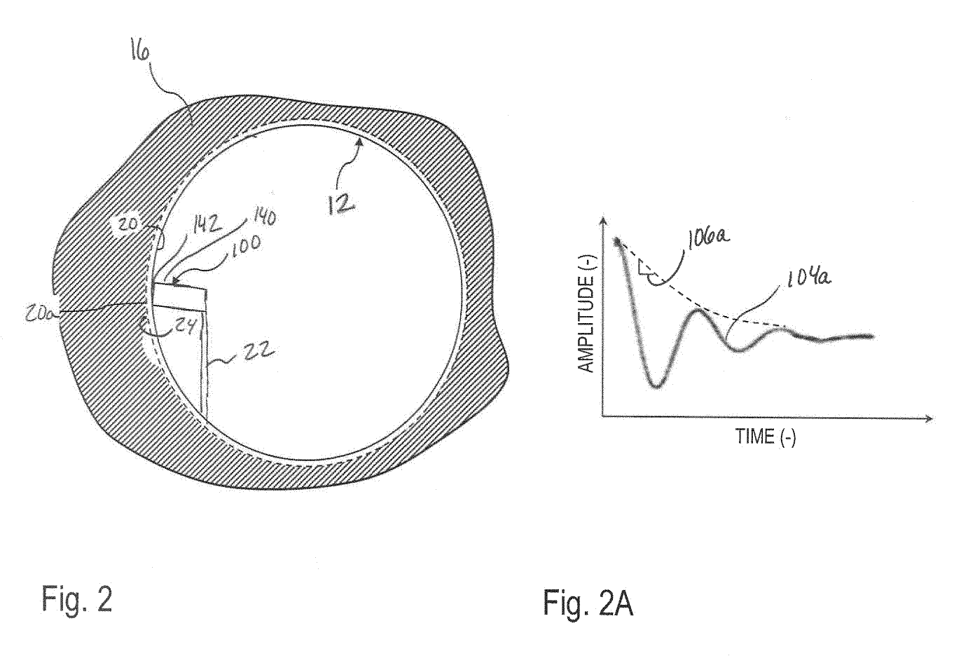

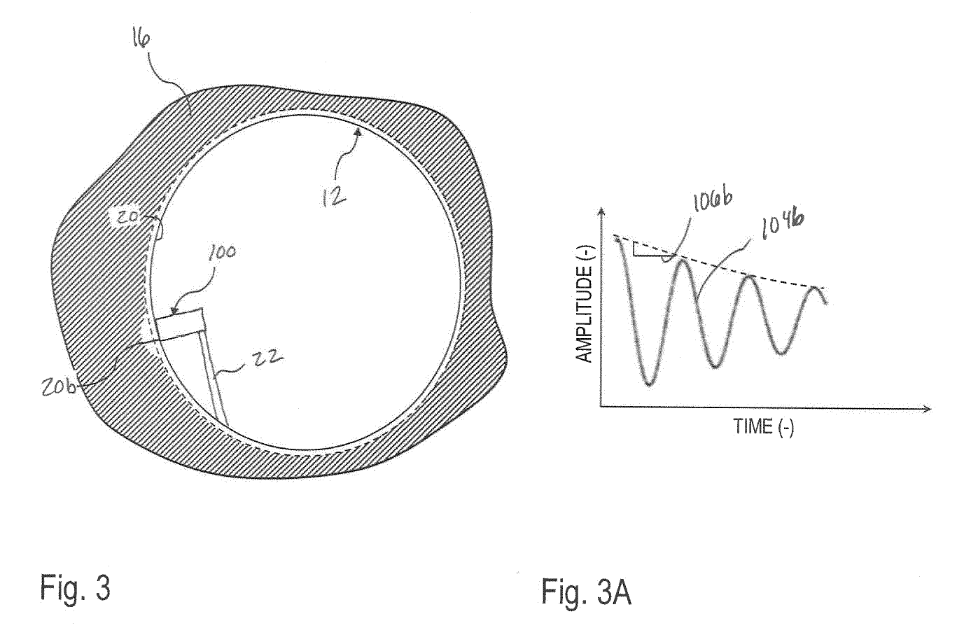

For instance, FIGS. 2 and 3 show axial views of an example of an infrastructure 12 provided in the form of a pipe fully buried into soil 16. In this case, the wall 20 is cylindrical.

As shown, the device 100 is sized and shaped to be handheld. For instance, the frame 140 is adapted to be received onto the wall 20 such as to remain in a fixed position at least during the inspection with aid of a support structure 22 and/or of a user. For instance, in the embodiment shown, the rests 142 of the frame 140 are maintained against the wall 20 where an inspection is to be performed. As it will be understood, the type of frame and its construction can vary from an embodiment to another.

The design of the device 100 is based on the fact that the wall 20 can resonate differently when soil is pushed-up against an outer face 24 of the infrastructure 12 in comparison to when there is no soil contacting the outer face 24. When a presence of soil 16 is present behind the wall 20 of the infrastructure 12, the vibratory energy generated by the mechanical strike is likely to be absorbed quickly by the soil in intimate contact with the outer face 24 of the infrastructure 12, translating into a relatively short-lived damped oscillation in the wall 20. In other words, the decay rate of that damped oscillation will be smaller than a decay rate threshold.

Conversely, when an absence of soil 16 is present behind the wall 20, meaning no soil is in contact with the outer face 24 of the infrastructure 12, the decay rate of the damped oscillation in the wall 20 will be longer (than the decay rate threshold) because the vibratory energy imparted to the wall 20 by the mechanical strike is not absorbed quickly by the soil (because there is less of it or none).

For instance, FIG. 2 shows the device 100 during an inspection of a first portion 20a of the wall 20 of the infrastructure 12, from the interior of the infrastructure 12. When the rests 142 of the device 100 are received on the wall 20, the user interface can receive a user input to cause the hammer assembly to mechanically strike the wall 20. This mechanical strike generally causes the first portion 20a to vibrate during a given period of time. The sensor 120, in contact with the wall 20, can sense vibrations associated with the vibrating first portion 20a and can generate a first vibration signal 104a indicative of an amplitude of the vibrations of the portion over a period of time following the mechanical strike.

An example of the first vibration signal 104a is shown in FIG. 2A. As mentioned above, the first vibration signal 104a can be used to evaluate the integrity of soil behind the first portion 20a. As it can be seen in this example, the first vibration signal 104a has a few cycles of different amplitudes and is characterized by a first decay rate 106a that can be determined by the processor 130.

In this embodiment, the processor 130 can be operated to compare the first decay rate 106a with a decay rate threshold that is stored on the memory. For instance, in the case of the first portion 20a, as expected from FIG. 2, the first decay rate 106a is smaller than a given decay rate threshold so the device 100 can evaluate that there is a presence of soil 16 behind the first portion 20a of the wall 20.

FIG. 3 shows the device 100 during an inspection of a second portion 20b of the wall 20 of the infrastructure 12, from the interior of the infrastructure 12. An inspection similar to the one above is performed with the device 100 which, in this case, generates a second vibration signal 104b.

An example of the second vibration signal 104b is shown in FIG. 3A. As mentioned above, the second vibration signal 104b can be used to evaluate the integrity of soil behind the second portion 20b. More specifically, as it can be seen, the second vibration signal 104b is characterized by a second decay rate 106b.

In this case, the processor 130 is operable to compare the second decay rate 106b with the decay rate threshold to determine the integrity of soil behind the wall 20. For instance, the second decay rate 106b is longer than the decay rate threshold so the device 100 can evaluate that there is an absence of soil 16 behind the second portion 20b of the wall 20.

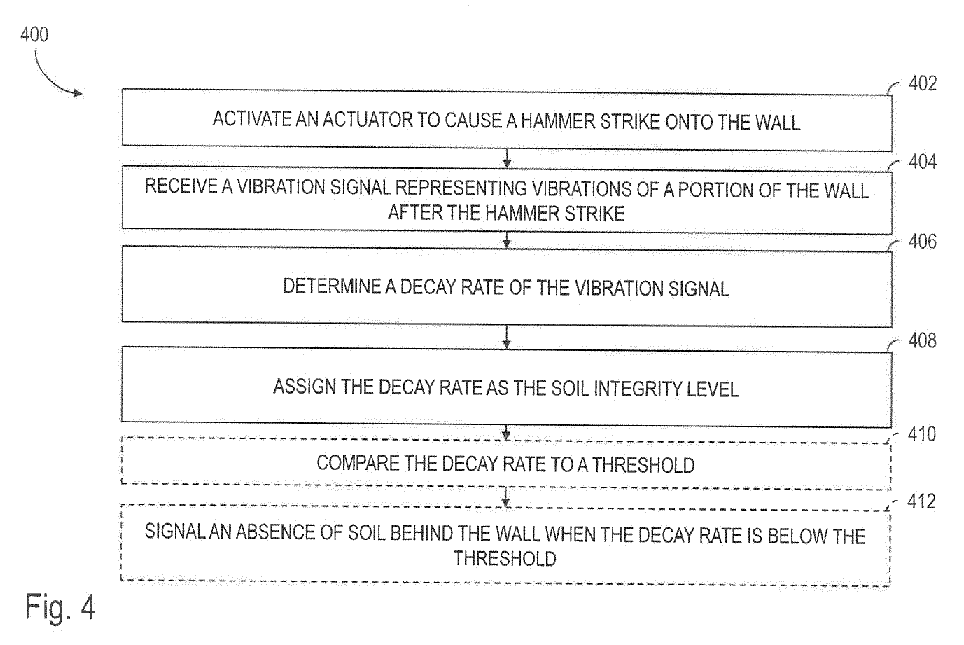

FIG. 4 shows a flow chart of an exemplary computer-implemented method 400 for evaluating an integrity level of soil behind a wall of an infrastructure. The method 400 can be performed using the device 100 and will be described with reference to FIG. 1.

At step 402, the device 100 activates an actuator of the hammer assembly 110 to cause a hammer strike onto the wall 20. The activation of the actuator of the hammer assembly 110 can include powering the actuator with an electrical signal. Depending on the type of actuator used, the electrical signal can vary. In some embodiments, this step can be initiated upon receiving a user input at the user interface 150.

At step 404, the device 100 receives a vibration signal representing vibrations of the portion of the wall 20 after the hammer strike. The vibration signal is measured using the sensor 120.

At step 406, the device 100 determines a signal strength and/or a decay rate of the vibration signal using the processor 130. In some embodiments, the vibration signal is analyzed by the processor 130 to find an equation which can fit the vibration signal. This equation can be of the form y=Ae^{kx} where y is the amplitude of the vibration signal, x is the sample's time stamp, A is a constant indicative of the signal strength and k is a constant indicative of the decay rate. In some other embodiments, the vibration signal is converted to a log scale using w=logₑ(y). Wth the data points for each test converted to a log scale, constants m and b can be determined such that the line w=mx+b is best fitted to the data. In this case, e^{b} is indicative of the signal strength and m is indicative of the decay rate.

At step 408, the device 100 assigns the signal strength and/or the decay rate as the soil integrity level. In some embodiments, the device 100 displays the soil integrity level on the user interface 150. The soil integrity level can be a value corresponding to the determined signal strength and/or decay rate in some embodiments.

In some embodiments, as per steps 410 and 412, the device 100 compares the signal strength and/or the decay rate to a threshold and signals an absence of soil behind the wall 20 when the signal strength and/or the decay rate is below the threshold. In some embodiments, the threshold is stored on the computer-readable memory 160. In some embodiments, the device 100 receives an input indicating which type of infrastructure (e.g., culverts, levees, storm sewers, foundations) or material (e.g., steel, concrete, wood, metal, plastics) is being inspected. In this way, the threshold can be selected among a plurality of thresholds each associated with a respective type of infrastructure or material.

The processor 130 may comprise more than one processor and/or any suitable devices configured to cause a series of steps to be performed so as to implement the computer-implemented method 400 such that software instructions 170 (see FIG. 1), when executed by a processor 130 or other programmable apparatus, may cause the execution of functions/acts/steps specified in the methods described herein. The processor 130 may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory 160 may comprise any suitable known or other machine-readable storage medium. The memory 160 may comprise non-transitory computer readable storage medium such as, for example, but not limited to, an electronic, magnetic, optical, electromagnetic, infrared, or semiconductor system, apparatus, or device, or any suitable combination of the foregoing. The memory 160 may include a suitable combination of any type of computer memory that is located either internally or externally to device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory may comprise any storage means (e.g., devices) suitable for retrievably storing machine-readable instructions executable by processor.

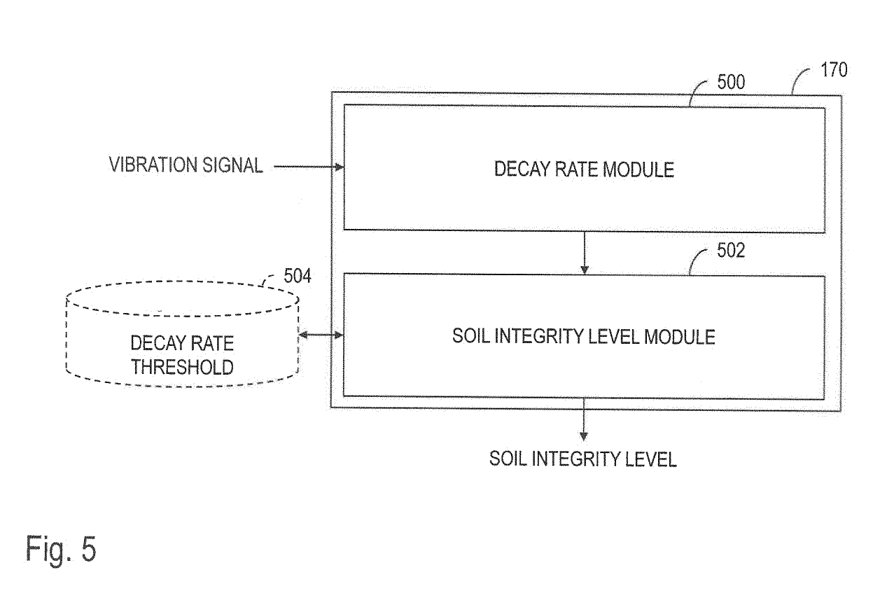

FIG. 5 is a block diagram of an exemplary embodiment of the device 100, which can be implemented by the processor 130. As depicted, a signal strength and decay rate module 500 and a soil integrity level module 502 embody the software instructions 170 shown in FIG. 1.

The signal strength and decay rate module 500 is configured to activate the actuator of the hammer assembly 110, as per step 402, to receive a vibration signal, as per step 404, and to determine a decay rate of the vibration signal, as per step 406. Once determined, the decay rate is provided to the soil integrity level module 502.

The soil integrity level module 502 receives the decay rate from the signal strength and decay rate module 500 and assigns the decay rate as the soil integrity level, as per step 408. Once determined, the soil integrity level can be displayed on a user interface and/or stored on a database 504 coupled to the soil integrity level module 502. Previously stored soil integrity levels can form history data accessible by the soil integrity level module 502.

The soil integrity level module 502 can also be configured to obtain a decay rate threshold, to compare the decay rate to the decay rate threshold, as per step 410, and to signal an absence of soil behind the wall 20 when the decay rate is below the decay rate threshold, as per step 412. The decay rate threshold can be stored in the database 504 or in any other storage medium.

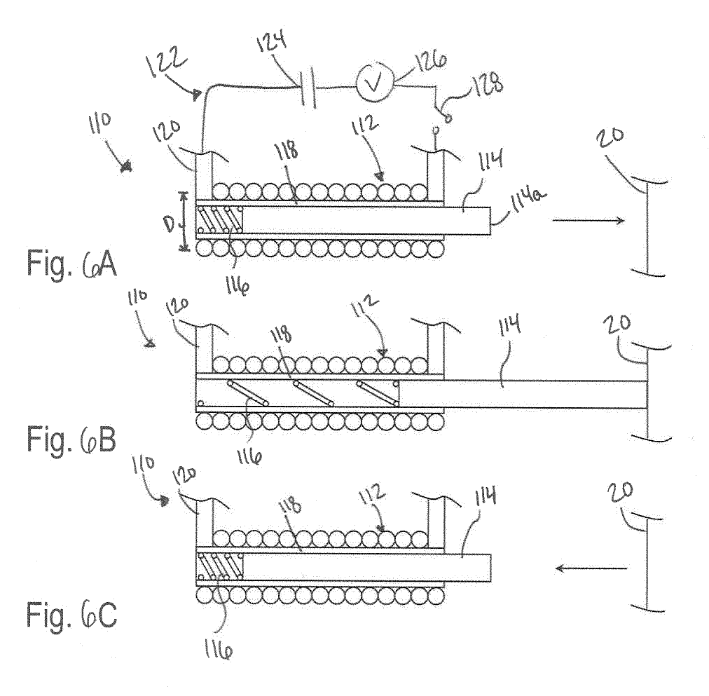

As it will be understood, different embodiments of the hammer assembly 110 can be used. For instance, FIGS. 6A-C show an embodiment of the hammer assembly 110 which includes an actuator 112 and a hammer element 114.

The actuator 112 is fixedly mounted to the frame 140, and the hammer element 114 is actuatable by the actuator 112. During use, the actuator 112 can be used to actuate the hammer element 114 to move from a rest position to a second position protruding from the frame and towards the wall 20 to strike it. The mechanical strike between the hammer element 114 and the wall 20 is of sufficient importance to cause the portion to vibrate for a satisfactory period of time and at satisfactory amplitudes.

As shown in FIGS. 6A-C, the hammer element 114 has a biasing element 116 so that the hammer element 114 can be biased to a retracted position after the mechanical strike. This can prevent subsequent strikes of the hammer element 114 on the given portion from happening, which may add undesirable artefacts to the vibration signal. In this embodiment, the biasing element 116 is provided in the form of a compression spring. The biasing element 116 is optional as, in this embodiment, retracting the hammer element 114 can be performed by the actuator 112.

As shown, the hammer element 114 is provided in the form of an electromechanical hammer. More specifically, the hammer assembly 110 has the actuator 112 which is provided in the form of a solenoid actuator. In this example, the actuator 112 includes a guiding sleeve 118 around which is provided a number of turns N of a conductive wire 120 of a given diameter D. In this example, the hammer element 114 is made of a ferromagnetic material such that when the actuator 112 is powered, an electromotive force forces the hammer element 114 to be outwardly projected. As it can be seen, the hammer element 114 is slidably received into the guiding sleeve 118 of the actuator 112.

At FIG. 6A, the actuator 112 is provided as part of an electrical circuit 122 having a capacitive element 124 (e.g., a large value capacitor), a charge pump 126 and an electrical switch 128. Prior to actuating the hammer element 114, the charge pump 126 charges the capacitive element 124 so that a given amount of charges is stored therein. When a user input is received via the user interface, the processor is operable to close the electrical switch 128 of the electrical circuit 122 which causes the charges stored in the capacitive element 124 to be dumped in the conductive wire 120, thus creating the electromotive force and the desired mechanical strike. By repetitively dumping the same amount of charges into the conductive wire 120 at each mechanical strike, the electromotive force can be known and calibrated.

It is noted that the processor 130 monitors the voltage level on the capacitive element 124 and when it reaches a satisfactory level, the charge pump 126 is stopped and the charge in the capacitive element 124 is maintained at a given level.

Following the projection of the hammer element 114, the head 114a strikes the wall 20 which causes extension of the biasing element 116 as shown in FIG. 6B. The extension of the biasing element 116 stores energy that is used to retract the head 114a of the hammer element 114 inwardly back towards the frame as shown in FIG. 6C. More specifically, the head 114a of the hammer element 114 projects just far enough to strike against the wall 20 of the infrastructure 12, then is quickly retracted by the biasing element 116, preventing multiple contacts with the wall 20.

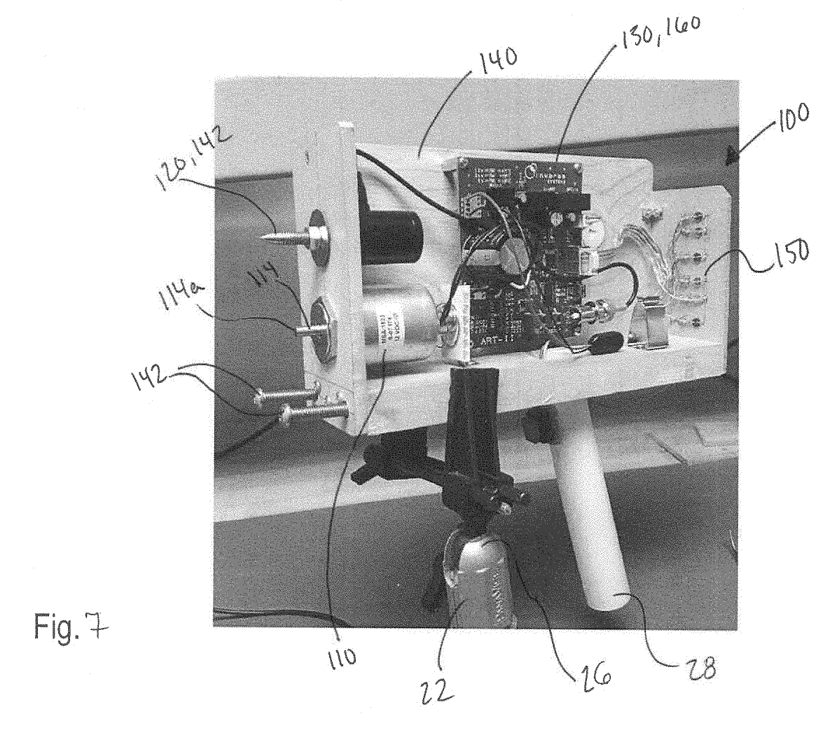

FIG. 7 shows an image representative of the device 100. As shown, the frame 140 of the device 100 is open to show its interior. In this case, the frame 140 has a cover to close the frame 140 in order to protect its internal components. In this example, the sensor 120 is made integral to one of the three rests 142. As it can be seen, the support structure 22 is pivotably mounted to the support structure 22 via a joint 26. As depicted, a handle 26 is provided to pivot the frame 140 relative to the support structure 22 during use.

Providing the sensor 120 with a pointy tip has been found satisfactory to pick up vibrations. As shown, the hammer element 114 is in its rest position. The hammer element 114 is surrounded by the rests 142 such that when the hammer element 114 is projected outwardly, the head 114a protrudes from a plane formed by extremities of each rest 142. In this embodiment, it is noted that the sensor 120 is isolated vibration-wise from the hammer assembly 110 such that vibration generated by the hammer assembly 110 does not affect the vibration signal picked up by the sensor 120.

In this embodiment, the processor 130 and the memory 160 are provided in the form of an integrated-circuit. The user interface 150 includes a series of LEDs to display the soil integrity level. A red one of the LEDs can be lighted when an absence of soil behind the wall 20 is to be signaled whereas a green one of the LEDs can be lighted when a presence of soil behind the wall 20 is to be signaled. A yellow one of the LEDs can be lighted when it is determined that the decay rate is below the threshold but only by an acceptable amount.

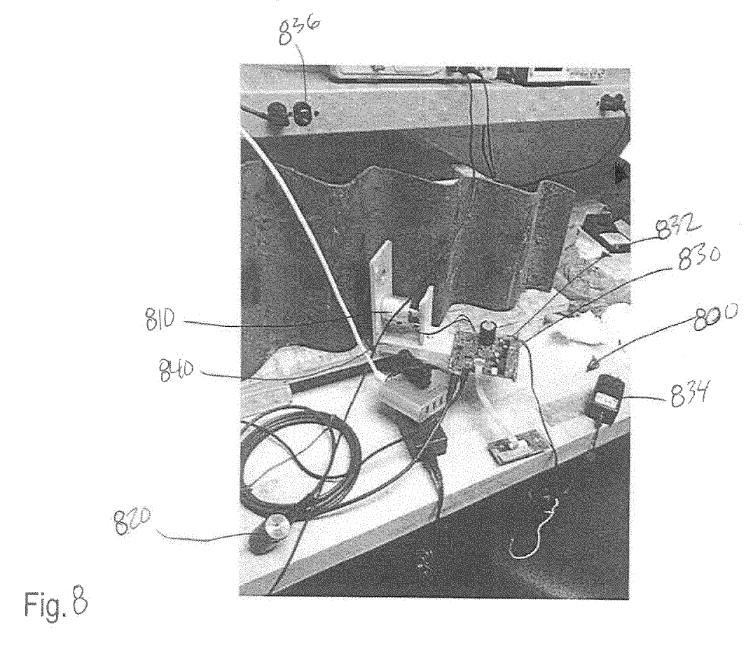

FIG. 8 shows an image representative of another example of a device 800 for evaluating the integrity of soil behind a wall of an infrastructure. As depicted, the device 800 has a frame 840, a hammer assembly 810, a sensor 820 and a processor 830.

As it will be understood, the processor 830 typically includes a power source port 832 connectable to a power source to power the hammer assembly 810, the sensor 820 and the user interface during use. In an embodiment, the power source port 832 is connected to a rechargeable battery mounted to the frame 840. In this embodiment, however, the power source port 832 is connected to an external power supply cord 834 supplying electricity from an external power source 836.

In an embodiment, it is contemplated that the user interface includes a display and that the processor is operable to display the soil integrity level on the display.

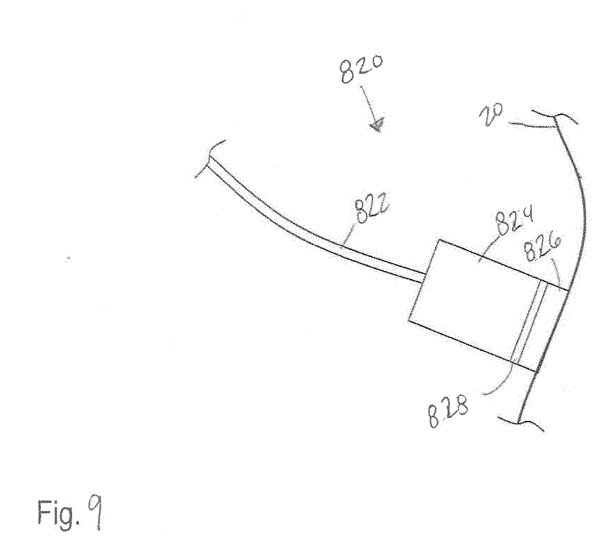

FIG. 9 shows a schematic view of another example of the sensor 820. In this embodiment, the sensor 820 and the processor are in communication via an electrical cord 822 allowing the sensor 820 to have a reduced impact on the way the vibratory energy is absorbed in the wall 20.

As shown in this embodiment, the sensor 820 includes an accelerometer 824 and an attachment head 826 secured to one another via a thin sheet 828 of hard rubber to improve mechanical wave propagation of the vibrations to the accelerometer 824. The attachment head 826 is used to attach the sensor 820 to any given portion of the wall 20. Any suitable type of attachment can be provided.

The accelerometer 824 can generate a vibration signal that is proportional to the acceleration in its axis of detection. When attached to the wall of the infrastructure with its axis normal to the direction of the vibrations, the vibration signal can be representative of an amplitude and of a frequency of the vibrations caused by the mechanical strike. Indeed, the vibrations of the portion of the wall can create a pushing and pulling force on the accelerometer which then gets converted into the vibration signal. An example of such an accelerometer is a commercially available piezoelectric accelerometer.

For instance, in this embodiment, the attachment head 826 includes a permanent magnet so as to be magnetically attached to the wall of the infrastructure when the latter is made of a ferromagnetic material.

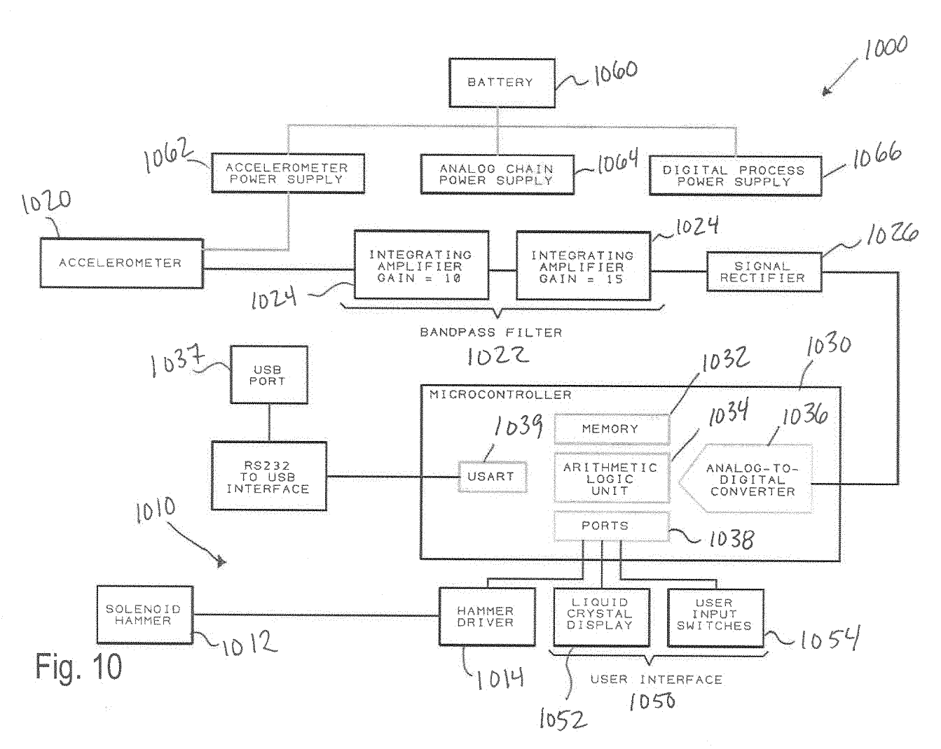

FIG. 10 shows a block diagram of another example of a device 1000 for evaluating the integrity of soil behind a wall of an infrastructure. As shown, the device 1000 has a hammer assembly 1010, a sensor 1020, a processor 1030, a user interface 1050 and a power source 1060.

More specifically, the hammer assembly 1010 has a solenoid hammer 1012 and a hammer driver 1014. The sensor 1020 includes an accelerometer. The processor 1030 includes a memory 1032, an arithmetic logic unit 1034, an analog-to-digital converter 1036 and ports 1038. The user interface 1050 includes a liquid crystal display 1052 and user input switches 1054. The liquid crystal display 1052 and the user input switches 1054 are connected to the processor 1030 via the ports 1038. The processor 1030 includes an input port 1039 connectable to a USB port 1037. The sensor 1020 is connected to the processor 1030 via a bandpass filter 1022 which includes two integrating amplifiers 1024 (with gains of 10 and 15, respectively) and a signal rectifier 1026. The power source 1060 is connected to the sensor 1020 via an accelerometer power supply 1062 and further includes an analog chain power supply 1064 and a digital process power supply 1066.

It is noted that the vibration signal is generally AC in nature (i.e. it swings positive and negative) and has a large direct current offset so it is coupled to a buffer circuit by way of a direct current blocking capacitor. The capacitor can be required to block the direct current power supply bias voltage of the sensor. An attenuator can be provided to allow matching of the voltage output level of the vibration signal to an input range of an analog-to-digital converter. The buffer circuits provide a low impedance source to a precision rectifier circuit placed ahead of the analog-to-digital converter. The precision rectifier can be required ahead of the analog-to-digital converter to ensure the signal fed to the converter is positive. The precision rectifier can invert the negative-going swings of the AC vibration signal, making them positive such that it can ensure that no portions of the vibration signal is lost due to polarity blocking. Another following buffer is provided between the precision rectifier and the analog-to-digital converter to again provide a low impedance source to the input circuitry of the converter. A low impedance source can ensure a relatively fast signal response by the sample-and-hold circuit that is part of the converter.

Moreover, it is noted that the analog-to-digital converter can be built into the processor. This analog-to-digital converter can have a 10-bit resolution. The analog-to-digital converter can be able to quantize the vibration signal voltage changes as 1 mV and at a rate of 9 600 conversions per second. The conversion results can be stored on a dynamic memory of the processor for further processing.

In some embodiments, the evaluation devices 100, 800 and/or 1000 may be accessible remotely from any one of a plurality of external devices over connections. The external devices may be any one of a desktop, a laptop, a tablet, a smartphone, and the like. The external devices may have a device application provided thereon as a downloaded software application, a firmware application, or a combination thereof, for accessing the devices 100, 800 and/or 1000. Alternatively, the external devices may access the device 100 via a web application, accessible through any type of Web browser. The external devices may be configured to receive the vibration signal, to determine the value indicative of soil integrity (e.g., a decay rate, an amplitude, a frequency) based on the vibration signal and to display the value.

The connections may comprise wire-based technology, such as electrical wires or cables, and/or optical fibers. The connections may also be wireless, such as RF, infrared, W-Fi, Bluetooth, and others. The connections may therefore comprise a network, such as the Internet, the Public Switch Telephone Network (PSTN), a cellular network, or others known to those skilled in the art. Communication over the network may occur using any known communication protocols that enable external devices within a computer network to exchange information. The Examples of protocols are as follows: IP (Internet Protocol), UDP (User Datagram Protocol), TCP (Transmission Control Protocol), DHCP (Dynamic Host Configuration Protocol), HTTP (Hypertext Transfer Protocol), FTP (File Transfer Protocol), Telnet (Telnet Remote Protocol), SSH (Secure Shell Remote Protocol).

In some embodiments, each device 100, 800 and 1000 is provided at least in part on any one of external devices. For example, each device 100, 800 and 1000 may be configured as a first portion provided in the frame 140 to obtain and transmit the vibration signal and/or the decay rate to a second portion, provided on one of the external devices. The second portion may be configured to receive the vibration signal and/or the decay rate, as per steps 404 and 406 of the method 400, and perform any one of steps 408 to 412 on one of the external devices. Alternatively, each device 100, 800 and 1000 is provided entirely on any one of the external devices and is configured to receive from the vibration signal and/or the decay rate. Also alternatively, each device 100, 800 and 1000 is configured to transmit, the connections, one or more of the vibration signal and/or the decay rate. Other embodiments may also apply.

One or more databases, such as database 504 may be provided locally on any one of the devices 100, 800, 1000 and the external devices, or may be provided separately therefrom. In the case of a remote access to the database 504, access may occur via the connections taking the form of any type of network, as indicated above. The various database 504 or other described herein may be provided as collections of data or information organized for rapid search and retrieval by a computer. The database 504 may be structured to facilitate storage, retrieval, modification, and deletion of data in conjunction with various data-processing operations. The database 504 may be any organization of data on a data storage medium, such as one or more servers. The database 504 illustratively has stored therein raw data representing a plurality of features of the inspection, the features being, for example, a relation between the decay rate and the type of material or infrastructure.

Each computer program described herein may be implemented in a high level procedural or object oriented programming or scripting language, or a combination thereof, to communicate with a computer system. Alternatively, the programs may be implemented in assembly or machine language. The language may be a compiled or interpreted language. Computer-executable instructions may be in many forms, including program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

Various aspects of the present device 100, 800 and/or 1000 may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments. Although particular embodiments have been shown and described, it will be obvious to those skilled in the art that changes and modifications may be made without departing from this invention in its broader aspects. The appended claims are to encompass within their scope all such changes and modifications.

It is contemplated that the processor can amplify, rectify and/or filter the vibration signal prior to processing it. Further, the processor can also convert the vibration signal from an analog signal to a discrete digital signal.

As can be understood, the examples described above and illustrated are intended to be exemplary only. The scope is indicated by the appended claims.

What is claimed is:

1. A device for use in evaluating the integrity of soil behind a wall of an infrastructure, the device comprising:
a frame having a plurality of rests adapted to be received onto the wall during use;
a hammer assembly having an actuator fixedly mounted to the frame and a hammer element having a head movably mounted to the frame, the actuator being actuatable to move the head to strike the wall while the plurality of rests hold the frame in a fixed position relative to the wall; and
a sensor configured and adapted to sense vibrations of a portion of the wall resulting from the strike and to generate a vibration signal indicative thereof.

2. The device of claim 1 further comprising a computer mounted to the frame and connected to receive the vibration signal, and software instructions stored in the computer, the software instructions being executable by the computer to measure a value indicative of soil integrity based on the vibration signal.

3. The device of claim 2 further comprising a display connected to the computer and configured to display the value indicative of soil integrity.

4. The device of claim 1 further comprising a user interface configured and adapted to receive a user input to trigger the actuation.

5. The device of claim 1 wherein the sensor is made integral to a sensing one of the plurality of rests.

6. The device of claim 5 wherein the sensing rest has a pointed tip.

7. The device of claim 5 wherein the sensor has an accelerometer secured to the sensing rest.

8. The device of claim 1 wherein the sensor is mounted to the frame and vibrationally isolated from the hammer assembly.

9. The device of claim 1 further comprising a biasing element mounted between the hammer element and the frame and biasing the hammer element to a retracted position.

10. The device of claim 9 wherein the biasing element is a compression spring.

11. The device of claim 1 wherein the actuator is a solenoid actuator, the hammer element being made of a ferromagnetic material, and the hammer element being electromagnetically engageable by a magnetic field emitted by the solenoid actuator.

12. The device of claim 1 wherein the hammer assembly is surrounded by the plurality of rests.

13. The device of claim 1 further comprising a rechargeable battery mounted to the frame and powering the hammer assembly, the sensor and the processor.

14. A computer-implemented method of evaluating an integrity level of soil behind a wall of an infrastructure, the method comprising:
activating an actuator to cause a hammer strike onto the wall;
receiving a vibration signal representing vibrations of a portion of the wall after the hammer strike;
determining at least one of a signal strength and a decay rate of the vibration signal; and
assigning the at least one of the signal strength and the decay rate as the soil integrity level.

15. The computer-implemented method of claim 14 further comprising:
comparing the at least one of the signal strength and the decay rate to a threshold; and
signaling an absence of soil behind the wall when the at least one of the signal strength and the decay rate is below the threshold.

16. The computer-implemented method of claim 15 wherein the threshold is stored on a computer-readable memory.

17. The computer-implemented method of claim 14 further comprising displaying the soil integrity level on a user interface.

18. The computer-implemented method of claim 14 further comprising initiating the computer-implemented method upon reception of a user input.

19. The computer-implemented method of claim 14 wherein the at least one of the signal strength and the decay rate is the decay rate.

20. A device for evaluating an integrity level of soil behind a wall of an infrastructure, the device comprising:
a computer-readable memory having stored thereon program code executable by a processor; and
a processor configured for executing the program code, the processor being configured for:
activating an actuator to cause a hammer strike onto the wall;
receiving a vibration signal representing vibrations of a portion of the wall after the hammer strike;
determining at least one of a signal strength and a decay rate of the vibration signal; and
assigning the at least one of the signal strength and the decay rate as the soil integrity level.

21. The device of claim 20 wherein the processor is configured for:
comparing the at least one of the signal strength and the decay rate to a threshold; and
signaling an absence of soil behind the wall when the at least one of the signal strength and the decay rate is below the threshold.

22. The device of claim 21 wherein the threshold is stored on the computer-readable memory.

23. The device of claim 20 further comprising a display configured for displaying the soil integrity level.

24. The device of claim 20 wherein the processor is configured for initiating the computer-implemented method upon reception of a user input from a user interface.

25. The device of claim 20 wherein the at least one of the signal strength and the decay rate is the decay rate.
